(19) United States
(12) Patent Application Publication
(10) Pub. No.: US 2015/0324102 A1
(43) Pub. Date: Nov. 12, 2015

(54) Method for Quickly Changing a User Interface and Computer Program Thereof and Electronic Device for Using the Same

(71) Applicant: Linktel Inc., Taipei (TW)

(72) Inventors: Hong-Lin Lee, Taipei (TW); Wen-Hsiung Tsai, Taipei (TW); Tzu-I Yang, Taipei (TW)

(21) Appl. No.: 14/453,697

(22) Filed: Aug. 7, 2014

(30) Foreign Application Priority Data
May 9, 2014 (TW) 103116638

(51) Int. Cl. G06F 3/0484

(52) U.S. Cl. CPC G06F 3/04847; G06F 3/04842

(57) ABSTRACT

A method for quickly changing a user interface is disclosed. The method is applied to an electronic device with at least two user interfaces. The user interfaces can be displayed via a screen of the electronic device, wherein the user interfaces include a first interface and a second interface. The method includes the following steps of: displaying a virtual button on the screen via the first interface; receiving a change instruction generated by clicking the virtual button; changing a user interface displayed on the screen from the first interface to the second interface.

### BACKGROUND OF THE INVENTION

1. Field of the Invention

The present invention relates to a method for quickly changing a user interface displayed via an electronic device.

2. Description of the Related Art

The User Interface (UI) is a medium for communication and message exchanges between users and systems, and it is used to provide a user a software system to use the hardware in a computer conveniently and efficiently so as to achieve the two-way interaction with the machine.

Nowadays, if smartphones have the Android™ operating system installed with two user interfaces, the user can choose one of them to use. When changing the user interfaces, the user must touch the home button on the smartphone first to make the phone screen display the menu of user interfaces, and then the user must select the desired user interface from a menu. After the selection step is completed, the user interface will be changed. This approach to changing interfaces requires that a user perform two operational gestures, which is a little bit inconvenient.

### SUMMARY OF THE INVENTION

The primary object of the present invention is to provide a method of displaying a virtual button via a screen such that a user can click it to quickly change user interfaces.

To achieve the above-mentioned objects, the method for quickly changing a user interface is used in an electronic device having at least two user interfaces which can be displayed via a screen of the electronic device such that a user can use one of the at least two user interfaces to use the electronic device, wherein the at least two user interfaces comprise a first interface and a second interface. The method for quickly changing a user interface of the present invention comprises the following steps: displaying a virtual button on the screen via the first interface; receiving a change order generated from the virtual button clicked by the user; and changing the first interface displayed on the screen to the second interface according to the change order.

According to an embodiment of the present invention, after the user interface displayed on the screen is changed from the first interface to the second interface, the method further comprises: displaying the virtual button on the screen via the second interface.

According to an embodiment of the present invention, the first interface and the second interface comprise a plurality of operation interfaces; the homepage button is displayed on a screen via a homepage operation interface of the first interface or second interface.

According to an embodiment of the present invention, the second interface is an exclusive interface of Skype™.

The present invention also provides a computer program product used for a method for quickly changing a user interface. The abovementioned method can be applied when the computer program product is accessed and executed by an electronic device.

The present invention also provides an electronic device having at least two user interfaces which include a first interface and a second interface. The electronic device comprises a main part, a screen, a memory and a processor. The screen is combined with a main part, wherein the at least two user interfaces can be displayed via the screen to provide a user one of the at least two user interfaces to use the electronic device. The memory is set in the main part and used to store a computer program product used for a method for quickly changing a user interface. The processor is set in the main part and connected to the memory, wherein the processor is used to execute the computer program product to achieve the abovementioned method for quickly changing a user interface.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a device structure drawing of the electronic device of the present invention.

FIG. 2 presents a schematic drawing of the electronic device displaying the first interface.

FIG. 3 presents a schematic drawing of the electronic device displaying the second interface.

FIG. 4 is a flowchart of the present invention illustrating the steps of the method for quickly changing a user interface.

### DETAILED DESCRIPTION OF THE PREFERRED EMBODIMENT

To clarify the above and other purposes, features, and advantages of this invention, a specific embodiment of this invention is especially listed and described in detail with the attached figures as follows.

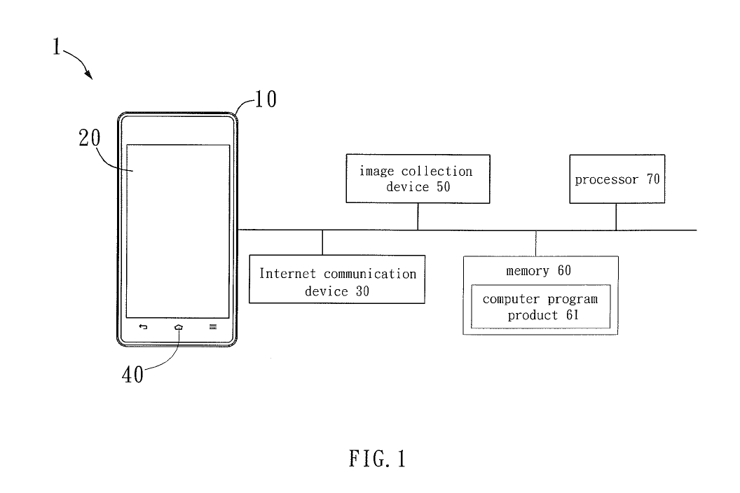

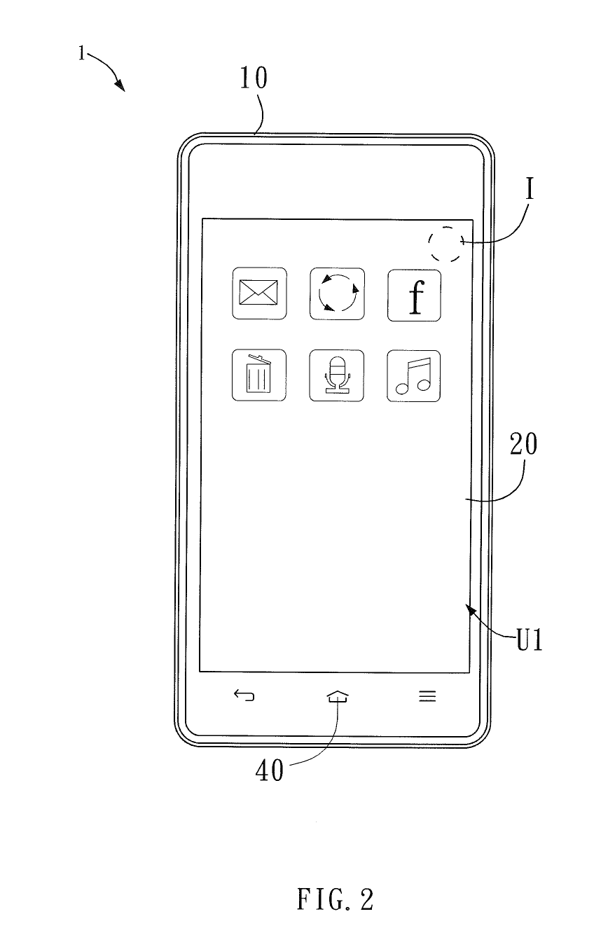

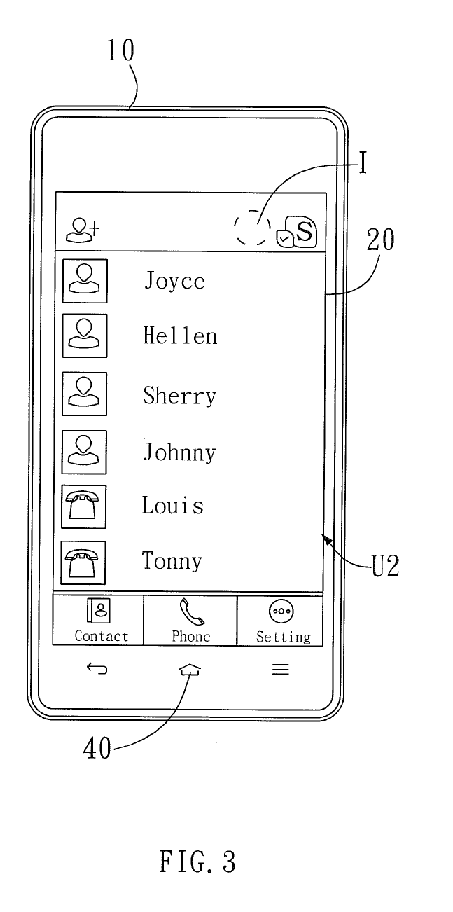

Please refer to FIG. 1 to FIG. 3. FIG. 1 is a device structure drawing of the electronic device of the present invention. FIG. 1 is a device structure drawing of the electronic device of the present invention; FIG. 2 presents a schematic drawing of the electronic device displaying the first interface; FIG. 3 presents a schematic drawing of the electronic device displaying the second interface.

As shown in FIG. 1, in an embodiment of the present invention, the computer program product 61 for the method of quickly changing a user interface is used in an electronic device 1. The electronic device 1 comprises a main part 10, a screen 20, an Internet communication device 30, a homepage button 40, an image collection device 50, a memory 60 and a processor 70, and the electronic device 1 has at least two user interfaces. In an embodiment of the present invention, the electronic device 1 is a smartphone, but the present invention is not limited thereto. The electronic device 1 can also be a tablet or any electronic product having similar functions of processing.

In an embodiment of the present invention, the user interfaces comprise a first interface U1 (as shown in FIG. 2) and a second interface U2 (as shown in FIG. 3), wherein one of the first interface U1 and the second interface U2 can be displayed via the screen 20 such that a user can operate the electronic device 1 via the first interface U1 or the second interface U2.

The first interface U1 and the second interface U2 respectively have a plurality of operation interfaces. In an embodiment of the present invention, the second interface is an exclusive interface of Skype™. When the user interface executed by the electronic device 1 is an exclusive interface of Skype™, the electronic device 1 becomes an electronic device for exclusively executing the Skype™ communication software program.

The screen 20 is combined with the main part 10 and is used to display the first interface U1 or the second interface U2.

As shown in FIG. 1, the Internet communication device 30 is set in the main part 10 and is used to connect to the Internet such that the electronic device 1 can be used for Internet communication.

The homepage button 40 is combined with the main part 10. The function of the homepage button 40 is that after the user clicks the homepage button 40, the screen 20 will display the homepage in the user interface being executed. That is, the homepage button 40 is a common “home” button in present smartphones.

The image collection device 50, such as a video camera, is combined with the main part 10 and used to collect image information, such as an image of the face of the user, such that the handheld electronic device 1 can be used for the function of video communication.

The memory 60 is set in the main part 10 and is used to store the computer program product 61 for the method of quickly changing a user interface.

The processor 70 is set in the main part 10 and electrically connected to the screen 20, the homepage button 40, the image collection device 50 and the memory 60. The processor 70 is used to perform the computer program product 61. After the electronic device 1 accesses and executes the computer program product 61, the following method for quickly changing a user interface of the present invention can be completed.

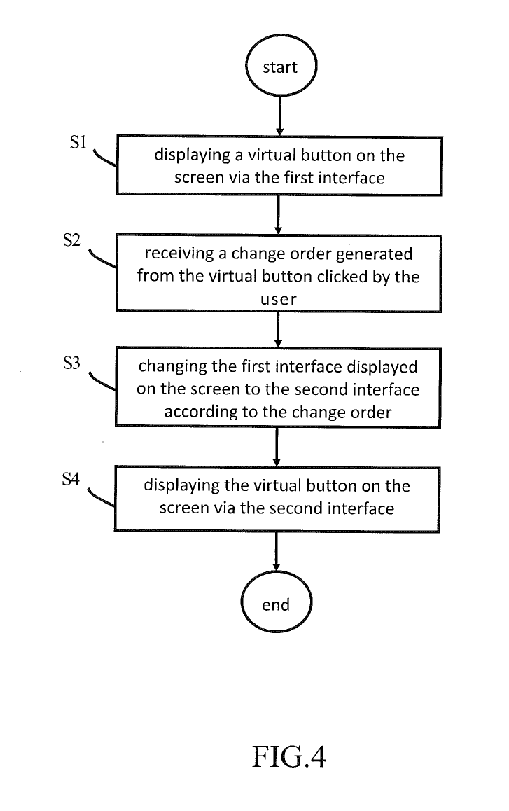

Please refer to FIG. 1 to FIG. 4 to understand the detailed steps of the method for quickly changing a user interface of the present invention, wherein FIG. 4 is a flowchart of the present invention illustrating the steps of the method for quickly changing a user interface. It should be noted that, although the electronic device 1 is used as an example to explain the method for quickly changing a user interface disclosed in the present invention, the method is not limited to the electronic device 1.

Step S1: displaying a virtual button on the screen via the first interface.

As shown in FIG. 2, when the screen 20 of the electronic device 1 displays the first interface U1, the present invention will display a virtual button I on the screen 20 via the first interface U1, which is provided for a user to click it whenever necessary for quickly changing a user interface. In the present embodiment of the present invention, the virtual button I is displayed on the screen 20 via the homepage operation interface of the first interface U1, but the present invention is not thus limited.

Step S2: receiving a change order generated from the virtual button clicked by the user.

When the user wants to change the user interface, the user needs only to click the virtual button I, and the electronic device 1 will receive the change order generated from the virtual button clicked by the user.

Step S3: changing the first interface displayed on the screen to the second interface according to the change order.

After receiving the change order, the electronic device 1 will change the interface displayed on the screen from the first interface to the second interface according to the change order. Meanwhile, so that the user will still be able to change the user interfaces quickly when using the second interface U2 displayed on the screen 20, the virtual button I for inputting the change order will be displayed on the screen 20 (as shown in FIG. 3) via the homepage operation interface of the second interface U2 after the present invention changes the interface displayed on the screen from the first interface U1 to the second interface U2. That is, the virtual button I is stilled display on the screen 20 via the second interface U2 (Step S4).

It should be noted that, although a few exemplary embodiments of the present invention have been shown and described, the present invention is not limited to the described exemplary embodiments. Instead, it will be appreciated by those skilled in the art that changes may be made to these exemplary embodiments without departing from the principles and spirit of the invention, the scope of which is defined by the claims and their equivalents.

What is claimed is:

1. A method for quickly changing a user interface used in an electronic device having at least two user interfaces which can be displayed via a screen of the electronic device to provide a user one of the at least two user interfaces to use the electronic device, wherein the at least two user interfaces comprise a first interface and a second interface and the method comprises:
displaying a virtual button on the screen via the first interface;
receiving a change order generated from the virtual button clicked by the user; and
changing the interface displayed on the screen from the first interface to the second interface according to the change order.

2. The method as claimed in claim 1, wherein after the interface displayed on the screen is changed from the first interface to the second interface, the method further comprises:
displaying the virtual button on the screen via the second interface.

3. The method as claimed in claim 2, wherein the first interface and the second interface comprise a plurality of operation interfaces, and the virtual button is displayed via one homepage user interface of the first interface or the second interface.

4. The method as claimed in claim 3, wherein the second interface is an exclusive interface of Skype™.

5. A computer program product used for a method for quickly changing a user interface, wherein the methods as claimed in claim 1 can be applied when the computer program product is accessed and executed by an electronic device.

6. An electronic device having at least two user interfaces which include a first interface and a second interface, wherein the electronic device comprises:
a screen combined with a main part, wherein the at least two user interfaces can be displayed via the screen to provide a user one of the at least two user interfaces to use the electronic device;
a memory set in the main part and used to store a computer program product used for a method for quickly changing a user interfaces; and
a processor set in the main part and connected to the memory, wherein the processor is used to execute the computer program product to achieve the following steps:
displaying a virtual button on the screen via the first interface;
receiving a change order generated from the virtual button clicked by the user; and
changing the interface displayed on the screen from the first interface to the second interface according to the change order.

7. The electronic device as claimed in claim 6, wherein after the interface displayed on the screen is changed from the first interface to the second interface, the electronic device further achieves:
displaying the virtual button on the screen via the second interface.

8. The electronic device as claimed in claim 7, wherein the first interface and the second interface comprise a plurality of user interfaces, and the virtual button is displayed via one homepage operation interface of the first interface or the second interface.

9. The electronic device as claimed in claim 8, wherein the second interface is an exclusive interface of Skype™.
